(19) United States
(12) Patent Application Publication
(10) Pub. No.: US 2014/0372204 A1
(43) Pub. Date: Dec. 18, 2014

(54) Automatically Applying Tracking Codes to Electronic Content Published Via a Social Media Service

(71) Applicant: Adobe Systems Incorporated, San Jose, CA (US)

(72) Inventors: Jeffrey Burdette Jordan, Orem, UT (US); Craig Christopher Stoe, Mill Valley, CA (US); Scott Jeremy Kleper, San Francisco, CA (US); Mark Carlos Lanett, San Francisco, CO (US); Tyler William Carlton, Highland, UT (US)

(21) Appl. No.: 13/915,917

(22) Filed: Jun. 12, 2013

(51) Int. Cl. G06Q 30/02; G06Q 50/00

(52) U.S. Cl. CPC G06Q 30/0246; G06Q 50/01
USPC 705/14.45

(57) ABSTRACT

Systems and methods for are provided for automatically applying a tracking code to content items accessible via a social media service. In one embodiment, a method is executed by a processor. The processor generates a tracking code identifying a marketing campaign. The processor publishes the content item via the social media service with a link to an electronic content source and the tracking code. The processor generates analytics based on the tracking code. The analytics track multiple interactions with the electronic content source originating from the link to the electronic content source included with the content item as published via the social media service.

### TECHNICAL FIELD

This disclosure relates generally to computer-implemented methods and systems and more particularly relates to automatically applying tracking codes to content items published via a social media service.

### BACKGROUND

Social media services may be used by providers of products and services to augment digital marketing efforts. For example, a content provider may integrate social media into a digital marketing plan by creating an account for the provider on a social media network, establishing relationships with other subscribers of the social media network, and sharing promotional content with the subscribers via the social media network. The content provider may track measurable business results resulting from social media promotional efforts, such as the number of sales attributable to content provided via the social network.

Prior solutions for attributing social media activity to sales and other business metrics may present shortcomings. For example, associating tracking codes to posts and other content published via a social media service may involve several manual steps performed by an analyst or other user, such as manually entering a tracking code with each social media post. Moreover, prior solutions for attributing social media activity to business metrics may allow analysts to determine the overall effectiveness of a marketing campaign while failing to provide information as to the relative effectiveness of each specific social media post for the marketing campaign.

### SUMMARY

In an example embodiment, a method is executed by a processor to automatically generate tracking code for electronic content published via a social media service. The embodiment also involves generating a tracking code identifying a marketing campaign. The embodiment also involves applying the tracking code to a content item. The embodiment also involves publishing the content item via a social media service. The content item includes a link to an electronic content source and the tracking code. The embodiment also involves generating analytics based on the tracking code. The analytics track multiple interactions with the electronic content source originating from the link to the electronic content source included with the content item as published via the social media service.

These illustrative embodiments are mentioned not to limit or define the disclosure, but to provide examples to aid understanding thereof. Additional embodiments are discussed in the Detailed Description, and further description is provided there.

### BRIEF DESCRIPTION OF THE FIGURES

These and other features, embodiments, and advantages of the present disclosure are better understood when the following Detailed Description is read with reference to the accompanying drawings, where:

FIG. 1 is a block diagram depicting example computing systems for implementing certain embodiments;

FIG. 2 is a modeling diagram depicting an example flow of communications between a social media marketing application and a social media service;

FIG. 3 is a modeling diagram depicting an example flow of communications among a social media client application, the social media service, an electronic content source accessible via the social media service, and the social media marketing application;

FIG. 4 is a modeling diagram depicting an example graphical interface provided by the social media marketing application for automatically generating tracking code for electronic content published via the social media service;

FIG. 5 is a modeling diagram depicting an example graphical interface provided by the social media marketing application for automatically generating tracking code for electronic content published via the social media service;

FIG. 6 is a modeling diagram depicting an example electronic content item as displayed by a social media client application accessing the social media service;

FIG. 7 is a modeling diagram depicting an example web page provided by the electronic content source in response to an interaction with the electronic content item published via the social media service; and

FIG. 8 is a flow chart illustrating an example method for automatically applying a tracking code to content items accessible via a social media service.

### DETAILED DESCRIPTION

Computer-implemented systems and methods are disclosed for automatically applying a tracking code to content items accessible via a social media service. A suitable software application can generate tracking code, associate the tracking code with a link included with a post or other content published via a social media service, and correlate interactions with the social media post to interactions with an external website or other content provider accessible via the link included in the social media post. Automatically applying tracking codes to content items accessible via a social media service can obviate the need for generating tracking codes for campaigns and/or manually entering tracking codes with content published via a social media service. For example, a link including a unique tracking code for a post to a social media service can be automatically generated “behind the scenes” such that an analyst, developer, or other user is not required to manually generate the tracking code or post the tracking code with the link.

The following non-limiting example is provided to help introduce the general subject matter of certain embodiments. An entity, such as an online software provider, may use multiple marketing campaigns associated with a software product being promoted. A marketer for the software provider can select one of the marketing campaigns via a social media marketing application. The marketer can select a start and end date for the campaign, such as start and end dates for a time period in which the software product will be provided at a promotional price. The marketer can create electronic content for the campaign, such as a posting to a social media service (e.g., Facebook®, Twitter®, Google®, etc.). The posting can advertise the software product being promoted during the time period. The social media marketing application can automatically generate a tracking code to be included with the posting when published via the social media service. The social media marketing application can automatically create a miniaturized uniform resource locator (“URL”) for a web page at the software provider's website featuring the product being promoted and/or a webpage associated with the marketing campaign. The social media marketing application can automatically associate the miniaturized URL with the tracking code. The social media marketing application can cause the posting to be published to the social media service. The social media marketing application can subsequently use the tracking code to track interactions with the software provider's website that originate from the social media posting (e.g., interactions with the website originating from “click-throughs” from the posting on the social media service to the product page on the website). The social media marketing application can also generate analytics for the campaign based on different tracking codes specific to different postings, thereby allowing the marketer to determine the effectiveness of different social media postings for the same marketing campaign.

In accordance with some embodiments, a social media marketing application is used to identify a marketing campaign associated with a social media service. A social media marketing application can include any software application suitable for managing, integrating, and/or otherwise using social media services in digital marketing efforts. A non-limiting example of a social media marketing application is Adobe® Social. The social media marketing application generates a tracking code identifying the marketing campaign. The social media marketing application applies the tracking code to a content item, such as (but not limited to) a posting to a social media service. The social media marketing application publishes the content item via the social media service. The published content item includes a link to an electronic content source. The social media marketing application generates analytics based on the tracking code. The analytics can be used for tracking interactions with the electronic content source originating from the link to the electronic content source included with the published content item. For example, the analytics can track that visits to a website hosted by a software provider originated from a posting or other electronic content item published via a social media service. Analytics can be generated using any suitable software. A non-limiting example of suitable software for generating analytics is the ARMATURE® Foundation software development platform.

As used herein, the term “electronic content” is used to refer to any type of media that can be rendered for display or use at a computing system or other electronic device. Electronic content can include text or multimedia files, such as images, video, audio, or any combination thereof. Electronic content can also include application software that is designed to perform one or more specific tasks at a computing system.

As used herein, the term “campaign” is used to refer to one or more messages that are associated with a common idea or theme. A message can be communicated via any suitable communication medium, such as (but not limited to) a social media service, a website, an e-mail, a direct mailer, a telephone communication, a text message, etc. For example, a campaign can include one or more posts to a social media service. A message for a campaign can include text content, image content, audio content, video content, or any combination thereof. Non-limiting examples of a common idea or theme can include a product or group of products being promoted, a service or group of services being promoted, a targeted group of recipients for the campaign, a desired action or group of actions to be performed in response to the campaign, etc.

As used herein, the term “social media service” is used to refer to systems and/or processes for facilitating interaction among entities for creating, sharing, exchanging, and otherwise using electronic content within virtual communities and networks. A social media service can be subscription-based. A social media service can provide systems and/or methods for entities subscribing to the social media service to create electronic content and/or exchange electronic content with other subscribers. Non-limiting examples of a social media service include Facebook®, Twitter®, YouTube®, Google®, and the like.

In additional or alternative embodiments, the social media marketing application can allow analytics to be generated that track activity at different electronic content sources originating from different posting or other electronic content items published to a social media service. The social media marketing application can generate multiple tracking codes identifying the marketing campaign and apply the multiple tracking codes to multiple content items. Each tracking code can be applied to a different respective content item. The social media marketing application can publish the different content items via one or more social media services. Each published content item includes a respective link to an electronic content source. The social media marketing application can generate multiple sets of analytics based on the multiple tracking codes for the multiple published content items. Each set of analytics can identify that a set of interactions with a given electronic content source originates from a given electronic content item published via a social media service. The social media marketing application can determine correlations between specific posts or other electronic content published via a social media service and interactions with an electronic content source associated with a marketing campaign. For example, the social media marketing application can identify which web site visits originated from a given post to a social media site.

In some embodiments, the electronic content source can be provided by or otherwise correspond to an entity associated with the marketing campaign. The entity can be independent of an entity providing the social media service. For example, a software provider can host or otherwise be associated with a web site for selling products from the software provider. The software provider and the software provider's web site can be separate from and independent of a provider of a social media service utilized by the software provider for social media marketing efforts.

As used herein, the term “entity” is used to refer to an individual, organization, or other logical identity that can be uniquely identified by a social media service or other software application. An entity can be identified via one or more client accounts. A client account can include an identifier for an entity. A client account can also include one or more authentication credentials, such as a password, personal identification number, a security question and an associated answer, etc. The same entity may be associated with multiple client accounts. For example, an entity such as a business may be associated with a first client account for subscribing to a social media service and second client account for hosting or otherwise controlling content provided by a web site for the business.

The entity associated with the electronic content source may be a subscriber to the social media service. In some embodiments, publishing the content item via the social media service can include publishing the content item via the social media service such that the content item is accessible only to subscribers of the social media service. For example, a software provider may publish a post to a social media site such that the post is accessible only by other entities subscribing to a social media service accessible via the social media web site. In other embodiments, the content item via the social media service can include publishing the content item via the social media service such that the content item is accessible only to subscribers of the social media service that are associated with the entity via the social media service. For example, a software provider may publish a post to a social media site and specify that the post is accessible only by other subscribing entities that are “friends” or “contacts” of the software provider via the social media service.

The social media marketing application can reduce or eliminate manual interactions with social media applications by analysts or other individuals responsible for tracking the effectiveness of a given marketing campaign. In some embodiments, the social media marketing application can provide a graphical interface for generating a post or other electronic content item for a social media marketing campaign. The social media marketing application can receive input via the graphical interface, such as input identifying a given marketing campaign, input creating the content of the post to be displayed to subscribers of the social media service, and/or input identifying which groups of subscribers to the social media service will be able to access the content via the social media service. The social media marketing application can automatically generate a link to be embedded in or otherwise included with the post to the social media service. The social media marketing application can also automatically generate the tracking code to be included with the link. Automatically generating the link and the tracking code can include the tracking code being generated and applied to the content item independently from input being received via the graphical interface. Rather than an analyst or other user manually creating a specific link with tracking and posting the link to a social media site, the social media marketing application can automatically generate a link and a unique tracking code for a post “behind the scenes” such that an analyst or other user is not required to manually generate the tracking code or post the tracking code with the link. The automatically generated link with the tracking code can be published with a post to a social media service.

In additional or alternative embodiments, the social media marketing application can identify a start date and an end date for the marketing campaign based on the input received via the graphical interface. The social media marketing application can generate the analytics tracking interactions with the electronic content source during a time period defined based on at least one of the start date and the end date. The social media marketing application can generate the analytics during the time period independently of the input received via the graphical interface.

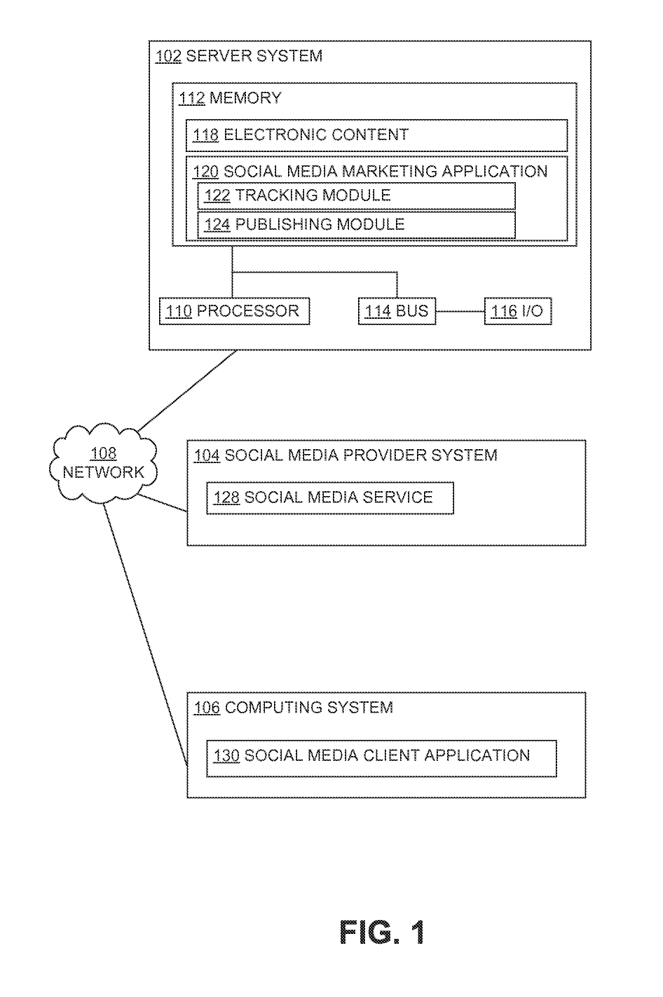

Referring now to the drawings, FIG. 1 is a block diagram depicting example computing systems for implementing certain embodiments. The example computing systems include a server system 102, a social media provider system 104, and a computing system 106 in communication via a data network 108.

The server system 102 includes a processor 110. Non-limiting examples of a processor 110 include a microprocessor, an application-specific integrated circuit (“ASIC”), a state machine, or other suitable processing device. The processor 110 can include any number of computer processing devices, including one. The processor 110 can be communicatively coupled to a computer-readable medium, such as a memory 112. The processor 110 can execute computer-executable program instructions and/or accesses information stored in the memory 112.

The memory 112 can store instructions that, when executed by the processor 110, cause the processor to perform operations described herein. The memory 112 may be a computer-readable medium such as (but not limited to) an electronic, optical, magnetic, or other storage device capable of providing a processor with computer-readable instructions. Non-limiting examples of such optical, magnetic, or other storage devices include read-only (“ROM”) device(s), random-access memory (“RAM”) device(s), magnetic disk(s), magnetic tape(s) or other magnetic storage, memory chip(s), an ASIC, configured processor(s), optical storage device(s), floppy disk(s), CD-ROM, DVD, or any other medium from which a computer processor can read instructions. The instructions may comprise processor-specific instructions generated by a compiler and/or an interpreter from code written in any suitable computer-programming language. Non-limiting examples of suitable computer-programming languages include C, C++, C#, Visual Basic, Java, Python, Perl, JavaScript, ActionScript, and the like.

The server system 102 may also include a bus 114. The bus 114 can communicatively couple one or more components of the server system 102.

The server system 102 may also include a number of external or internal devices, such as input or output devices. For example, the server system 102 is shown with an input/output (“I/O”) interface 116 for receiving input from input device and/or providing output to output devices.

FIG. 1 also illustrates electronic content 118 and a social media marketing application 120 comprised in the memory 112 of the server system 102. The social media marketing application 120 stored in the memory 112 can include a tracking module 122 and a publishing module 124. The social media marketing application 120 can configure the processor 110 to publish electronic content 118 via a social media service, such as a social media service 128 provided by the social media provider system 104. The social media marketing application 120 can also configure the processor 110 to track interactions with electronic content 118 via the social media service 128 by a social media client application 130 executed at a computing system 106. A non-limiting example of a social media marketing application 120 is Adobe® Social software.

The social media client application 130 can include one or more software modules for establishing communication with the social media service 128. In some embodiments, the social media client application 130 can be a stand-alone application. In other embodiments, the social media client application 130 can be embedded in another application, such a web browser application.

The server system 102 can include any suitable computing system for hosting the social media marketing application 120. In one embodiment, the server system 102 may be a single computing system, such as a server system. In another embodiment, the server system 102 may be a virtual server implemented using a number of computing systems connected in a grid or cloud computing topology.

The social media provider system 104 can include any suitable computing system for providing the social media service 128. In one embodiment, the social media provider system 104 may be a single computing system, such as a server system. In another embodiment, the social media provider system 104 may be a virtual server implemented using a number of computing systems connected in a grid or cloud computing topology.

The computing system 106 can include any suitable computing device or system for communicating via a data network 108 and executing the social media client application 130. Non-limiting examples of a suitable computing device or system include a desktop computer, a tablet computer, a smart phone, or any other computing device or system suitable for using electronic content.

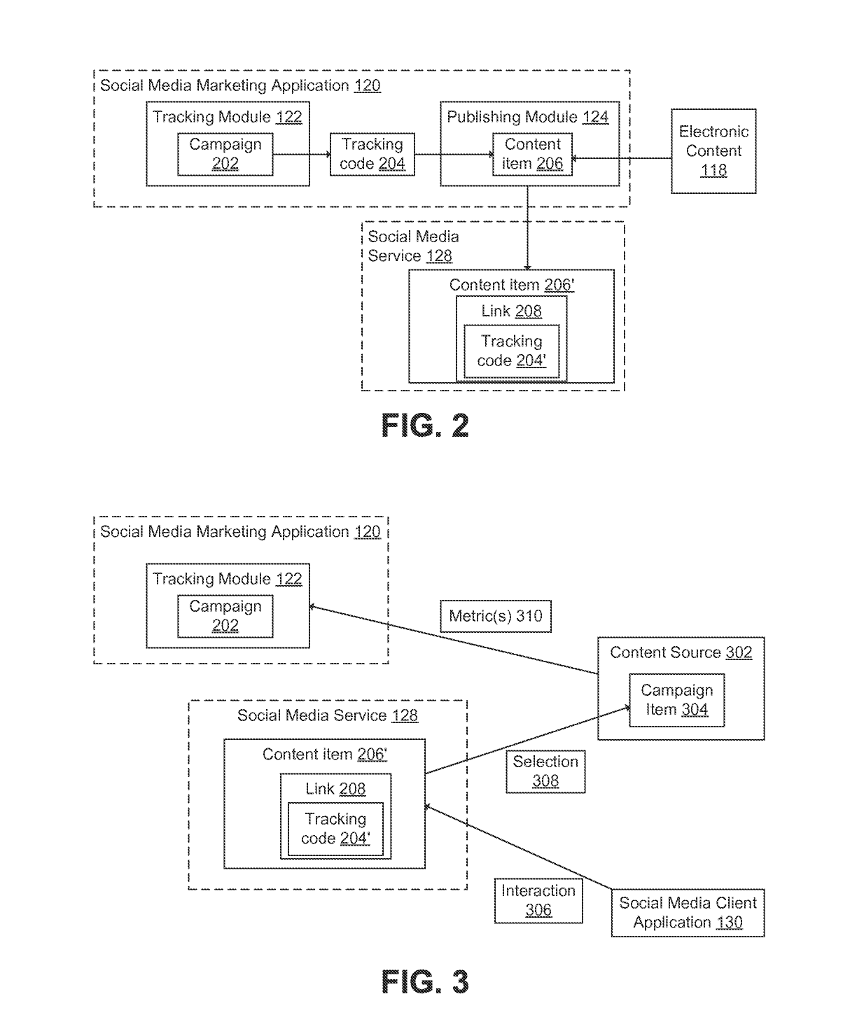

FIG. 2 is a modeling diagram depicting an example flow of communications between a social media marketing application 120 and a social media service 128.

The tracking module 122 can identify a campaign 202. The campaign 202 can be associated with a product, service, or other content provided by an entity. For example, an entity may be a software provider that sells one or more software products or services, such as a graphics editing program. The software provider may utilize one or more marketing campaigns to promote sales of the graphics editing program. A campaign 202 can be identified by the social media marketing application 120 as utilizing one or more social media services to promote a given product or service from the software provider or other content providing entity.

The tracking module 122 can generate tracking code 204. The tracking code 204 can identify the campaign 202. The tracking code 204 can include any suitable electronic content for identifying the campaign 202. A non-limiting example of the tracking code 204 is an alphanumeric string such as “304962A” that provides an identifier for the campaign 202.

The tracking module 122 can provide the tracking code 204 to the publishing module 124. The publishing module 124 can obtain an electronic content item 206 from the electronic content 118. In some embodiments, the content item 206 can be retrieved from a data store that includes the electronic content 118. In other embodiments, the social media marketing application 120 or another suitable application can provide an interface via which a user can generate the content item 206. A non-limiting example of a content item 206 includes text, images, sound, or some combination thereof to be published to the social media service 128.

The publishing module 124 can apply the tracking code 204 to the content item 206. Applying the tracking code 204 to the content item 206 can include generating a link 208 to be embedded in or otherwise included with the content item 206 as published via the social media service 128. The link 208 can provide access to a source of electronic content separate from the social media service 128. For example, the link 208 can be a URL to a website hosted at a network domain separate from and independent of the social media service. Applying the tracking code 204 to the content item 206 can also involve including the tracking code 204 with the link 208. Including the tracking code 204 with the link 208 can identify that a visit or other access to the source of electronic content via the link 208 is initiated via an interaction with the content item 206, as described below with respect to FIG. 3.

The publishing module 124 can provide the content item 206 with the applied tracking code 204 to the social media service 128 for publication. The publishing module 124 can request or otherwise cause the social media service 128 to publish the content item 206 with the applied tracking code 204 as a published content item 206′. The social media service 128 can provide access to the published content item 206′ that includes the link 208 and the tracking code 204′. One or more entities subscribing to the social media service 128 can view, access, or otherwise use the published content item 206′ via the social media service 128.

FIG. 3 is a modeling diagram depicting an example flow of communications among a social media client application 130, the social media service 128, an electronic content source 302 accessible via the social media service 128, and the social media marketing application 120.

The social media client application 130 can initiate an interaction 306 with the published content item 206′ that includes the tracking code 204′. The interaction 306 can include selecting a link 208 to the content source 302 embedded in or otherwise included with the content item 206′. Selecting the link 208 to the content source 302 can include clicking the link 208 or otherwise indicating the content source 302 is to be accessed.

A selection 308 of the link 208 can direct a user of the social media client application 130 to the content source 302. A non-limiting example of a content source 302 is a web site. The content source 302 can be associated with the entity utilizing the campaign 202. For example, a software provider may utilize the campaign 202 to induce visits to a web site or other content source 302 hosted by the software provider or otherwise used by the software provider to sell products. In some embodiments, the selection 308 of the link 208 included with the content item 206′ can direct a user of the social media client application 130 to a specific campaign item 304. For example, the content item 206′ may promote a specific software product by providing a link 208 to a web page at the content source 302 that includes a campaign item 304 corresponding to the promoted software product.

Including the tracking code 204 with the link 208 can identify that a visit or other access to the electronic content source 302 via the link 208 is initiated via the selection 308. For example, the tracking code 204 can be added as a URL parameter to a URL for accessing an electronic content source 302 such as a website. A web server hosting the website can use the tracking code 204 included in the URL parameter to uniquely identify a visit to the website. The web server can associate one or more interactions with website occurring during the visit with the tracking code 204. The web server can store or otherwise provide a record of the one or more interactions associated the tracking code 204.

The tracking module 122 of the social media marketing application 120 can obtain one or more metrics 310 based on the tracking code 204′. A non-limiting example of a metric 310 is a unique visit to the content source 302 and/or a viewing of the campaign item 304 that originates from the link 208 to the electronic content source 302 included with the published content item 206′. Another non-limiting example of a metric 310 is a download of the campaign item 304 or another electronic content item associated with the campaign 202. The tracking code 204′ included with the content item 206′ can allow the tracking module 122 to obtain a metric 310 identifying that a given interaction with the content source 302 originated from the published content item 206′. The tracking module 122 or another suitable software module of the social media marketing application 120 can generate one or more analytics based on the metrics 310. The analytics can describe the effectiveness of the content item 206′ in inducing users to access the content source 302. For example, analytics can identify how many of the visits to the content source 302 originating from the published content item 206′ ultimately resulted in a conversion, such as (but not limited to) a sale of a campaign item 304 being promoted via the campaign 202.

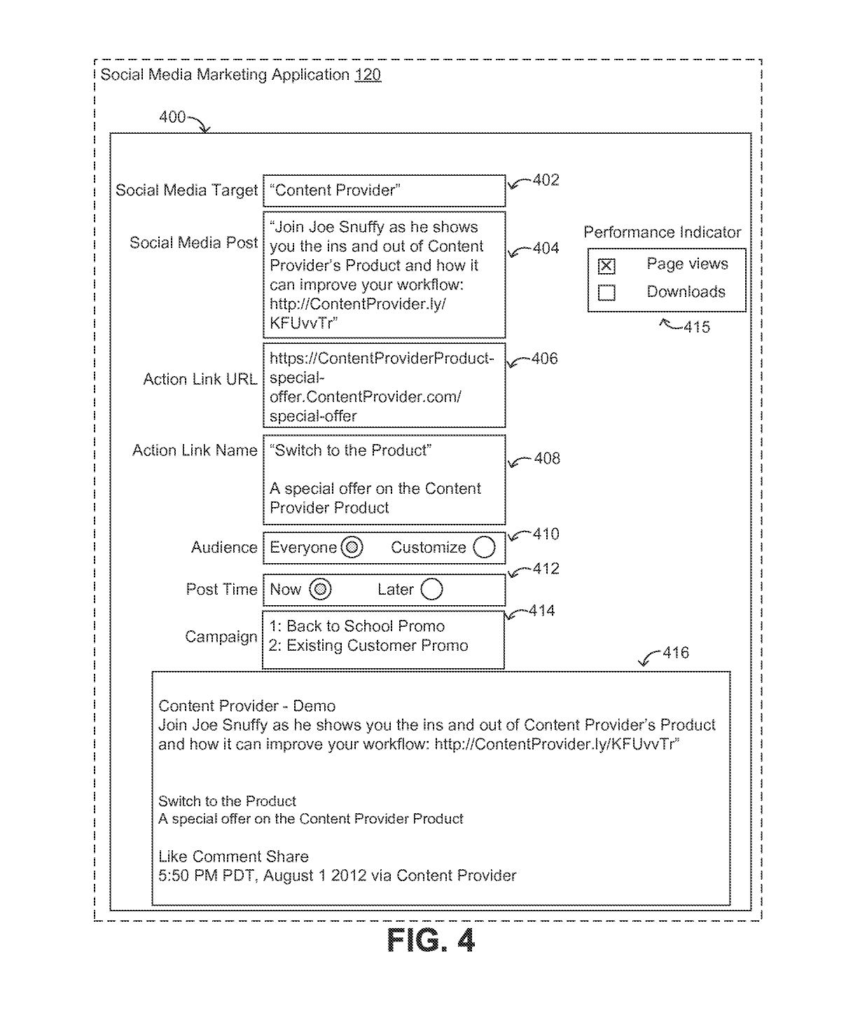

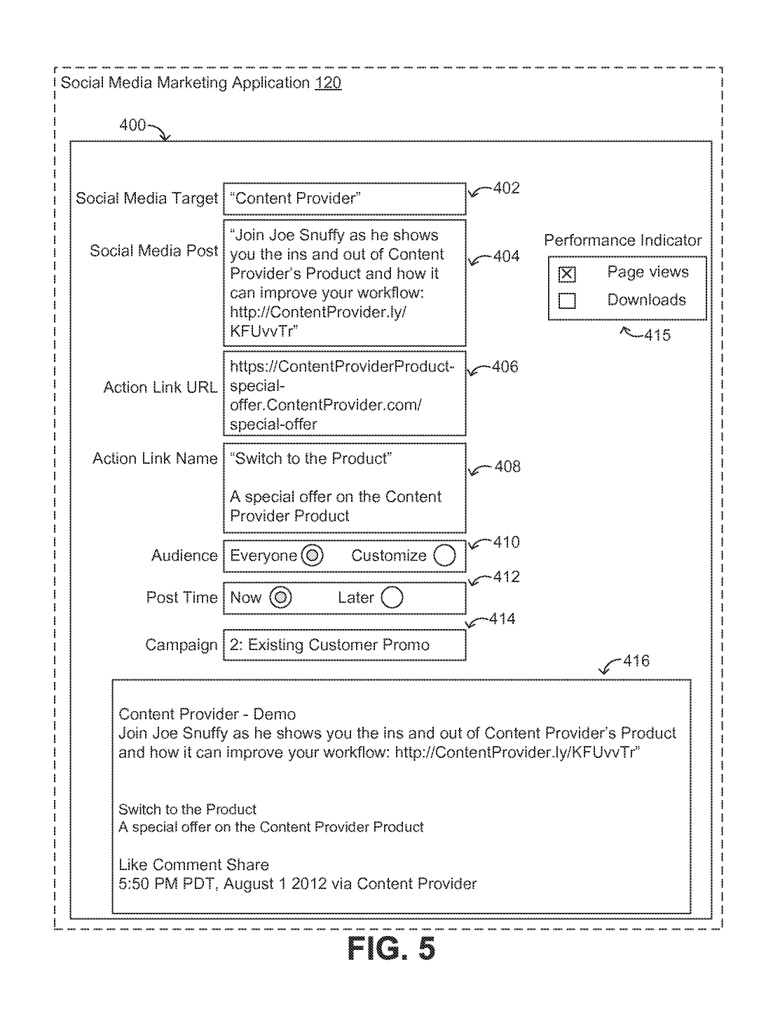

FIGS. 4-5 are modeling diagrams depicting an example graphical interface 400 provided by the social media marketing application 120 for automatically generating tracking code for electronic content published via the social media service 128. The graphical interface 400 can include a target field 402, a post field 404, a link field 406, a link name field 408, an audience field 410, a posting time field 412, a campaign field 414, a metric selection field 415, and a preview field 416.

The target field 402 can identify the entity utilizing the social media service 128 for digital marketing purposes. For example, as depicted in FIG. 4, the target field 402 identifies an entity named “Content Provider” that is utilizing the social media service 128.

The post field 404 can display at least some of the electronic content included in the content item 206 to be published via the social media service 128. For example, as depicted in FIG. 4, a user may input the text “Join Joe Snuffy as he shows you the ins and out of Content Provider's Product and how it can improve your workflow.” The text inputted into the post field 404 may be displayed to entities subscribing to the social media service 128 with the published content item 206′.

The link field 406 can display a URL or other link via which a content source 302 can be accessed via a data network. In some embodiments, the social media marketing application 120 can automatically populate the link field 406. For example, the social media marketing application 120 may select a URL for an entity identified in the target field 402. In other embodiments, the social media marketing application 120 can populate the link field 406 based on one or more inputs to the link field 406 by a user of the social media marketing application 120.

The social media marketing application 120 can generate the link 208 using the link specified in the link field 406 and the tracking code 204. For example, the link “https://ContentProviderProduct-special-offer.ContentProvider.com/special-offer” depicted in FIG. 5 can be a link to a website providing a product. The tracking code 204 can be an alphanumeric string associated with the campaign 202, such as “1234abc.” The social media marketing application 120 can generate a link 208 that includes the tracking code 204 as a parameter to be provided to the electronic content source 302 along with the request for a web page, such as “https://ContentProviderProduct-special-offer.ContentProvider.com/special-offer/id=1234abc.”

The link name field 408 can display text that is to be rendered as a hyperlink in the published content item 206′ for the link 208 generated by the social media marketing application 120.

The audience field 410 can identify which of the entities subscribing to the social media service 128 can access the published content item 206′ via the social media service 128. For example, the “Everyone” entry may be selected via a radio button or other suitable input to identify that published content item 206 is to be accessible by all entities subscribing to the social media service 128. The “Customize” entry may be selected via a radio button or other suitable input to identify that published content item 206 is to be accessible by entities subscribing to the social media service 128 that are also associated with the entity identified in the target field 402. For example, a published content item 206′ may be accessible only by other subscribing entities that are “friends” or “contacts” of the entity “Content Provider” in the social media service 128.

The posting time field 412 can identify a time period in which the content item 206′ is to be published.

The campaign field 414 can identify a campaign 202 with which the content item 206 is to be associated. For example, as depicted in FIG. 4, a user can access a drop-down list identifying a “Back to School Promo” campaign or an “Existing Customer Promo” campaign as available campaigns for the content item 206. The user can select either of the “Back to School Promo” campaign or the “Existing Customer Promo” campaign from the drop-down list, as illustrated by the selection of the “Existing Customer Promo” campaign in FIG. 5. The social media marketing application 120 can generate the tracking code 204 in response to a selection of the marketing campaign 202. The social media marketing application 120 can associate the tracking code 204 with the selected marketing campaign 202. The generation and association of the tracking code 204 with the selected marketing campaign 202 can be performed automatically by the social media marketing application 120 without input to the graphical interface 400 other than the selection of the marketing campaign 202.

The metric selection field 415 can identify one or more metrics 310 to be monitored for a campaign 202. For example, as depicted in FIG. 4, a user can select checkboxes for metrics 310 such as “page views” and “downloads.” Although FIG. 4 depicts a metric selection field that includes page views and downloads, any performance indicator suitable for evaluating the effectiveness of a campaign 202 can be included in the metric selection field 415.

The preview field 416 can provide a preview of the content item 206′. The preview displays the content item 206′ as displayed by a social media client application 130 accessing the social media service 128.

In some embodiments, the social media marketing application 120 can automatically generate a short URL for the link 208. A short URL can be a shortened version of the link 208 (e.g., “http://ContentProvider.ly/KFUvvTr”) that directs a browser application to the same web page or other network resource as the full version of the link (e.g., “https://ContentProviderProduct-special-offer. ContentProvider.com/special-offer/id=1234abc”).

In additional or alternative embodiments, the social media marketing application 120 can identify or otherwise obtain a link or other network resource locator from content in a post field 404. For example, the social media marketing application 120 can identify or otherwise obtain a URL or other network resource locator entered in line with other text in the post field 404. The social media marketing application 120 can generate a link 208 that includes tracking code 204 using the URL or other network resource locator obtained from text or other content in the post field 404.

Although FIGS. 4-5 depict an example graphical interface 400 that includes a target field 402, a post field 404, a link field 406, a link name field 408, an audience field 410, a posting time field 412, a campaign field 414, and a preview field 416, other implementations are possible. In some embodiments, a graphical interface 400 provided by the social media marketing application 120 can change or omit one or more of the target field 402, the post field 404, the link field 406, the link name field 408, the audience field 410, the posting time field 412, the campaign field 414, and/or the preview field 416. For example, a social media marketing application 120 can provide a graphical interface 400 without a link field 406 and can identify or otherwise obtain a link or other network resource locator from content in a post field 404.

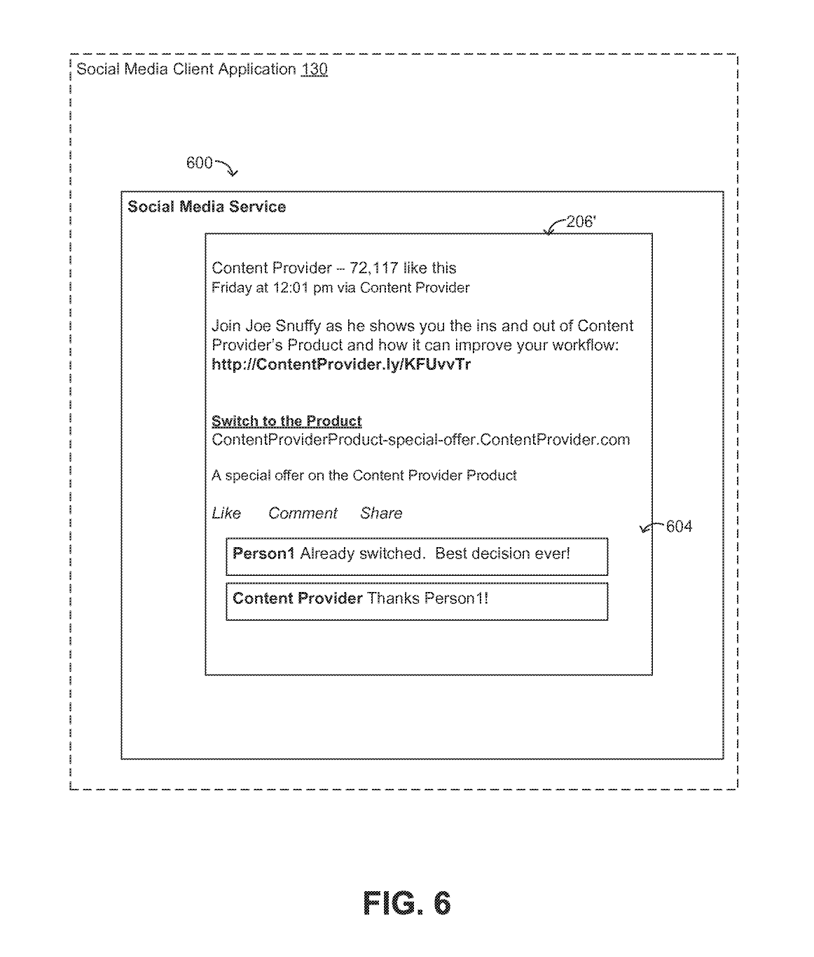

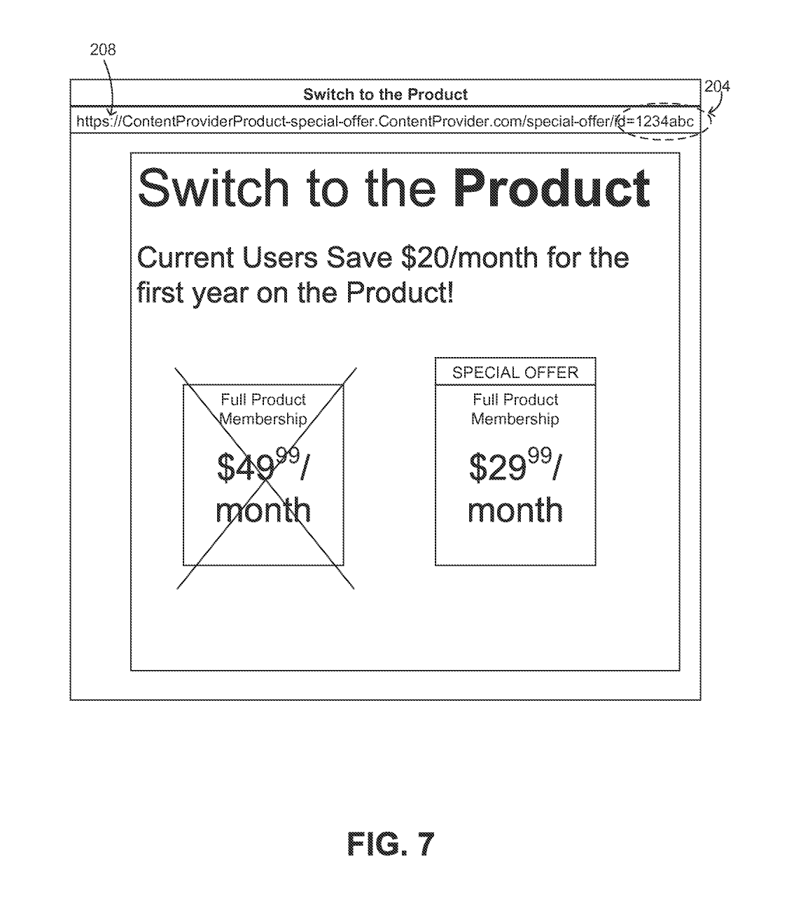

FIG. 6 is a modeling diagram depicting an example electronic content item 206′ as displayed by a social media client application 130 accessing the social media service 128. The social media client application 130 can provide a graphical interface 600 identifying the social media service 128 and displaying the published content item 206′. As depicted in FIG. 6, the social media service 128 can allow subscribing entities to add comments 604 to the published content item 206′.

In some embodiments, the published content item 206′ as displayed in the graphical interface 600 may not display the generated link 208 to a user. For example, as depicted in FIG. 6, the published content item 206′ can display hyperlinks such as “Switch to the Product” and/or “ContentProviderProduct-special-offer.ContentProvider.com”. Either of the hyperlinks can resolve to the generated link 208 (“https://ContentProviderProduct-special-offer.ContentProvider.com/special-offer/id=1234abc”) without the link 208 being displayed in the graphical interface 600.

FIG. 7 is a modeling diagram depicting an example web page 700 provided by the electronic content source 302 in response to an interaction with the electronic content item 206′ published via the social media service 128. The web page 700 can include link 208 that includes the tracking code 204 as a parameter to be provided to the electronic content source 302 along with a request for the web page 700 (e.g. “https://ContentProviderProduct-special-offer.ContentProvider.com/special-offer/id=1234abc”). The link 208 can be automatically generated by the social media marketing application 120. The social media marketing application 120 can generate a

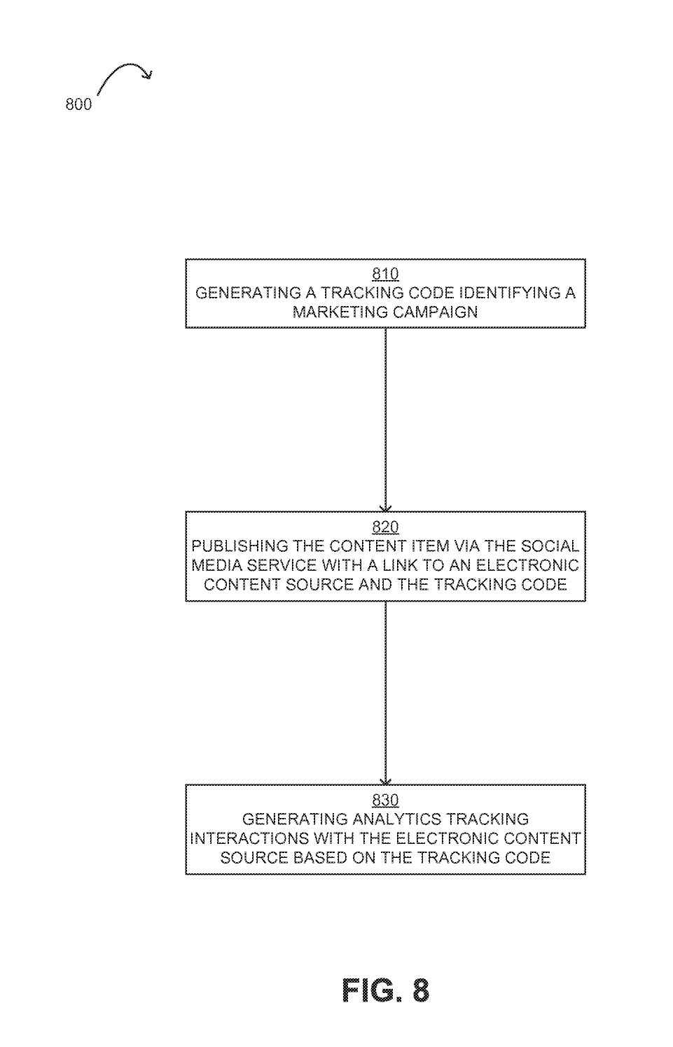

FIG. 8 is a flow chart illustrating an example method 800 for automatically applying a tracking code to content items accessible via a social media service. For illustrative purposes, the method 800 is described with reference to the system implementations depicted in FIG. 1 and the flow of communication depicted in FIGS. 2-3. Other implementations, however, are possible.

The method 800 involves generating a tracking code 204 identifying a marketing campaign 202, as shown in block 810. For example, the processor 110 executing on the server system 102 can execute the tracking module 122 to generate the tracking code 204.

A non-limiting example of the tracking code 204 is an alphanumeric string usable as an identifier of the campaign 202. The tracking code 204 can be generated automatically without receiving inputs from a user entering the tracking code 204 or a portion of the tracking code 204.

In some embodiments, the tracking module 122 of the social media marketing application 120 can identify a marketing campaign 202 that is associated with the social media service 128. The social media marketing application 120 can identify the campaign 202 via input to a graphical interface 400, as described above with respect to FIGS. 4-5. For example, the marketing campaign 202 can be selected from multiple available campaigns, as described above with respect to FIGS. 4-5.

The method 800 further involves publishing the content item 206 via the social media service 128 with a link 208 to an electronic content source 302, as shown in block 820. For example, the processor 110 executing on the server system 102 can execute the publishing module 124 to publish the content item 206 via the social media service 128. Publishing the content item 206 via the social media service 128 can include providing the content item 206 to the social media service 128 for publication, requesting or instructing the social media service 128 to publish the content item 206, and/or any other action executed by the publishing module 124 causing the content item 206 to be accessible via the social media service 128.

The publishing module 124 can apply the tracking code 204 to the content item 206. Applying the tracking code 204 to the content item 206 can include generating a link 208 that includes the tracking code 204 and associating the link 208 with the content item 206 for publication via the social media service 128. For example, the social media marketing application 120 can generate the tracking code 204 transparently to a user to the social media marketing application 120 (e.g., without requiring input from the user entering any portion of the tracking code 204). The social media marketing application 120 can generate a new link 208 from the link identified in link field 406. The new link 208 can include the link identified in link field 406 and the automatically generated tracking code 204. The new link 208 can be, for example, a URL that includes the tracking code 204 as a URL parameter.

The social media marketing application 120 can generate and apply the tracking code without requiring input to the graphical interface 400 that creates or identifies the tracking code. In some embodiments, the social media marketing application 120 can provide a graphical interface 400 for generating a post or other electronic content item 206 for a social media marketing campaign 202. The social media marketing application 120 can receive input via the graphical interface, such as input identifying a given marketing campaign 202, input creating the content of the post to be displayed to subscribers of the social media service 128 and/or input identifying which groups of subscribers to the social media service 128 will be able to access the content via the social media service 128. The social media marketing application 120 can automatically generate a link 208 to be embedded in or otherwise included with the content item 206. The social media marketing application 120 can also automatically generate the tracking code 204 to be included with the link 208. The automatically generated link 208 with the tracking code 204 can be published by the social media service 128 with the published content item 206′.

In some embodiments, the social media marketing application 120 can track activity at one or more electronic content sources 302 based on a specific electronic content item 206. For example, the social media marketing application 120 can generate multiple tracking codes 204 identifying the marketing campaign 202 and can apply the multiple tracking codes 204 to multiple content items 206. Each tracking code 204 can be applied to a different respective content item 206. The social media marketing application 120 can publish the different content items 206 via one or more social media services 128. Each tracking code 204 can be used to identify that a respective interaction with the electronic content source 302 originated from the respective content item 206 to which the tracking code 204 is applied.

In some embodiments, an entity associated with the electronic content source 302 and/or the campaign 202 may be a subscriber to the social media service 128. In some embodiments, publishing the content item 206 via the social media service 128 can involve specifying that all subscribers of the social media service 128 are allowed to access the content item via the social media service 128. In other embodiments, publishing the content item via the social media service 128 can include publishing the content item such that access to the content item via the social media service 128 is restricted to subscribers of the social media service 128 that are associated with the entity via the social media service 128. For example, a software provider may publish a post to a social media site and specify that the post is accessible only by other subscribing entities that are “friends” or “contacts” of the software provider via the social media service 128.

The method 800 further involves generating analytics tracking interactions with the electronic content source 302 based on the tracking code 204, as shown in block 830. For example, the processor 110 executing on the server system 102 can execute the tracking module 122 to generate analytics based on one or more metrics 310, as described above with respect to FIG. 3. The analytics can identify the relative effectiveness of the electronic content item 206′ in causing users to access the electronic content source 302 and/or perform some other interaction with respect to the electronic content source 302.

### General Considerations

Numerous specific details are set forth herein to provide a thorough understanding of the claimed subject matter. However, those skilled in the art will understand that the claimed subject matter may be practiced without these specific details. In other instances, methods, apparatuses, or systems that would be known by one of ordinary skill have not been described in detail so as not to obscure claimed subject matter.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provides a result conditioned on one or more inputs. Suitable computing devices include multipurpose microprocessor-based computer systems accessing stored software that programs or configures the computing system from a general purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The use of “adapted to” or “configured to” herein is meant as open and inclusive language that does not foreclose devices adapted to or configured to perform additional tasks or steps. Additionally, the use of “based on” is meant to be open and inclusive, in that a process, step, calculation, or other action “based on” one or more recited conditions or values may, in practice, be based on additional conditions or values beyond those recited. Headings, lists, and numbering included herein are for ease of explanation only and are not meant to be limiting.

While the present subject matter has been described in detail with respect to specific embodiments thereof, it will be appreciated that those skilled in the art, upon attaining an understanding of the foregoing, may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art.

1. A method executed by a processor, the method comprising:
generating a tracking code identifying a marketing campaign;
publishing the content item via a social media service, wherein the content item includes a link to an electronic content source and the tracking code; and
generating, based on the tracking code, analytics tracking a plurality of interactions with the electronic content source originating from the link to the electronic content source included with the content item as published via the social media service.

2. The method of claim 1, further comprising:
generating the link with the tracking code, wherein the link comprises a uniform resource locator having the tracking code as a parameter of the uniform resource locator; and
associating the generated link with the content item for publication via the social media service.

3. The method of claim 1, further comprising:
generating an additional tracking code identifying the marketing campaign;
applying the additional tracking code to an additional content item, wherein the additional content item is different from the content item;
publishing the additional content item via the social media service, wherein the additional content item includes an additional link to the electronic content source; and
generating, based on the additional tracking code, additional analytics tracking an additional plurality of interactions with the electronic content source originating from the additional link to the electronic content source included with the additional content item published via the social media service, wherein the additional analytics track the additional plurality of interactions separately from the analytics tracking the plurality of interactions, wherein the analytics and the additional analytics are associated with the marketing campaign.

4. The method of claim 1, wherein the electronic content source is provided by an entity, wherein the entity is associated with the marketing campaign and is independent of an additional entity providing the social media service.

5. The method of claim 4,
wherein the entity comprises a subscriber to the social media service;
wherein publishing the content item via the social media service comprises publishing the content item such that access to the content item via the social media service is restricted to subscribers of the social media service that are associated with the entity via the social media service.

6. The method of claim 4,
wherein the entity comprises a subscriber to the social media service,
wherein publishing the content item via the social media service comprises publishing the content item such that access to the content item via the social media service is restricted to subscribers of the social media service.

7. The method of claim 4, wherein the marketing campaign is associated with a product provided by the entity via the electronic content source.

8. The method of claim 1, further comprising:
providing a graphical interface; and
receiving input via the graphical interface;
wherein the marketing campaign and the content item are identified based on the input received via the graphical interface;
wherein the tracking code is generated and applied to the content item independently of the input received via the graphical interface.

9. The method of claim 8, further comprising:
identifying at least one of a start date and an end date for the marketing campaign based on the input received via the graphical interface;
wherein the analytics tracking the plurality of interactions with the electronic content source are generated during a time period based on the at least one of the start date and the end date independently of the input received via the graphical interface.

10. The method of claim 1, wherein access to electronic content provided via the social media service is restricted to subscribers of the social media service.

11. A non-transitory computer-readable medium embodying program code executable by a processing device, the non-transitory computer-readable medium comprising:
program code for generating a tracking code identifying a marketing campaign;
program code for publishing the content item via a social media service, wherein the content item includes a link to an electronic content source and the tracking code; and
program code for generating, based on the tracking code, analytics tracking a plurality of interactions with the electronic content source originating from the link to the electronic content source included with the content item as published via the social media service.

12. The non-transitory computer-readable medium of claim 11, further comprising:
program code for generating an additional tracking code identifying the marketing campaign;
program code for applying the additional tracking code to an additional content item, wherein the additional content item is different from the content item;
program code for publishing the additional content item via the social media service, wherein the additional content item includes an additional link to the electronic content source; and
program code for generating, based on the additional tracking code, additional analytics tracking an additional plurality of interactions with the electronic content source originating from the additional link to the electronic content source included with the additional content item published via the social media service, wherein the additional analytics track the additional plurality of interactions separately from the analytics tracking the plurality of interactions, wherein the analytics and the additional analytics are associated with the marketing campaign.

13. The non-transitory computer-readable medium of claim 11, further comprising program code for receiving the electronic content source from an entity, wherein the entity is associated with the marketing campaign and is independent of an additional entity providing the social media service.

14. The non-transitory computer-readable medium of claim 13,
wherein the entity comprises a subscriber to the social media service;
wherein publishing the content item via the social media service comprises publishing the content item such that access to the content item via the social media service is restricted to subscribers of the social media service that are associated with the entity via the social media service.

15. The non-transitory computer-readable medium of claim 13,
wherein the entity comprises a subscriber to the social media service,
wherein publishing the content item via the social media service comprises publishing the content item such that access to the content item via the social media service is restricted to subscribers of the social media service.

16. The non-transitory computer-readable medium of claim 13, wherein the marketing campaign is associated with a product provided by the entity via the electronic content source.

17. A system comprising:
a processor;
a non-transitory computer-readable medium communicatively coupled to the processor;
wherein the processor is configured to execute instructions embodied in the non-transitory computer-readable medium to perform operations comprising:
generating a tracking code identifying a marketing campaign;
publishing the content item via a social media service, wherein the content item includes a link to an electronic content source and the tracking code; and
generating, based on the tracking code, analytics tracking a plurality of interactions with the electronic content source originating from the link to the electronic content source included with the content item as published via the social media service.

18. The system of claim 17, wherein the processor is configured to execute additional instructions embodied in the non-transitory computer-readable medium to perform additional operations comprising:
providing a graphical interface; and
receiving input via the graphical interface;
wherein the marketing campaign and the content item are identified based on the input received via the graphical interface;
wherein the tracking code is generated and applied to the content item independently of the input received via the graphical interface.

19. The system of claim 18, wherein the processor is configured to execute additional instructions embodied in the non-transitory computer-readable medium to perform additional operations comprising identifying at least one of a start date and an end date for the marketing campaign based on the input received via the graphical interface;
wherein the analytics tracking the plurality of interactions with the electronic content source are generated during a time period based on the at least one of the start date and the end date independently of the input received via the graphical interface.

20. The system of claim 17, wherein access to electronic content provided via the social media service is restricted to subscribers of the social media service.
